(19) United States
(12) Patent Application Publication
(10) Pub. No.: US 2024/0106867 A1
(43) Pub. Date: Mar. 28, 2024

(54) RECOMMENDING NETWORK SECURITY RULE UPDATES BASED ON CHANGES IN THE NETWORK DATA

(71) Applicant: Citrix Systems, Inc., Fort Lauderdale, FL (US)

(72) Inventors: Saifulla Shaik, Cupertino, CA (US); Aikaterini Kalou, Patras (GR)

(21) Appl. No.: 17/968,200

(22) Filed: Oct. 18, 2022

Related U.S. Application Data
(63) Continuation of application No. PCT/GR2022/000052, filed on Sep. 28, 2022.

(51) Int. Cl. H04L 9/40; H04L 41/14

(52) U.S. Cl. CPC H04L 63/205; H04L 41/14

(57) ABSTRACT

The present solution provides systems and methods for recommending updated network security rules based on changes in the network data. The present solution can use a rule identifying an entity, an attribute of the entity and a value of the attribute. The solution can detect, responsive to monitoring the network environment, a change in one of the entity, the attribute or the value. The solution can generate, responsive to the detection, an updated rule. The solution can apply the updated rule to previous network traffic to which the rules was applied. In response to determining that effectiveness of the updated rule is greater than that of the prior rule, the solution can provide a recommendation to use the updated rule.

### CROSS-REFERENCE TO RELATED APPLICATION

This application is a continuation of and claims priority to International Application No. PCT/GR2022/000052, titled “RECOMMENDING NETWORK SECURITY RULE UPDATES BASED ON CHANGES IN THE NETWORK DATA,” and filed on Sep. 28, 2022, the contents of which is hereby incorporated herein by reference in its entirety for all purposes.

### FIELD OF THE DISCLOSURE

The present application generally relates to computing systems and environments, including but not limited to systems and methods for managing network security.

### BACKGROUND

Network traffic can vary widely based on the devices, systems, and applications that users utilize to access their network content. Network security can be affected as a result of these variations. System administrators can use different security tools and features to maintain network security in view of the changes on the network. As devices and applications used on the network vary over time, network security measures can change as well.

### SUMMARY

This summary is provided to introduce a selection of concepts in a simplified form that are further described below in the Detailed Description. This Summary is not intended to identify key features or essential features, nor is it intended to limit the scope of the claims included herewith.

Network security tools can allow system administrators to convert certain network security triage steps into rules. These rules can then operate on the network and help manage the network security. However, as the network ecosystem changes over time, such as due to new users, devices, applications or user behaviors on the network, previously established rules can lose their effectiveness over time. Manual updating of these rules can be time consuming and inefficient and sometimes difficult to implement. The present disclosure provides a solution that addresses this issue by monitoring the network data to identify changes in the network ecosystem and then based on those changes generates an updated rule whose effectiveness exceeds that of the prior rule it sets to replace. The present solution can then recommend the updated rule to the administrator, thereby updating the effectiveness of the network rules over time to account for the ongoing evolution of the network ecosystem.

In some aspects, the present solution can relate to a method. The method can include one or more servers establishing one or more rules for security of a network environment. Each of the one or more rules can identify an entity, an attribute of the entity and a value of the attribute. The one or more servers can detect, responsive to monitoring the network environment, a change in one of the entity, the attribute or the value. The one or more servers can generate, responsive to the detection, an updated one or more rules for security of the network environment based at least on the change. The one or more servers can apply, by the one or more servers, the updated one or more rules to previous network traffic to which the one or more rules were applied. The one or more servers can determine that an effectiveness of the updated one or more rules is greater than effectiveness of the one or more rules. The one or more servers can provide, responsive to the determination, a recommendation to use the updated one or more rules.

The method can include the one or more servers detecting the change in one of the entity, the attribute or the value. The change can be determined based on a comparison of an updated state of one of the entity, the attribute or the value and a prior state of the one of the entity, the attribute or the value. The one or more servers can monitor a value graph. The value graph can correspond to the network environment. The value graph can include a representation of the network environment using the entity, the attribute and the value. The one or more servers can detect the change in one of the entity, the attribute or the value in the value graph.

The one or more servers can generate the updated one or more rules using at least one of the entity or the attribute of the one or more rules. The one or more servers can generate the updated one or more rules responsive to detecting that the change in one of the entity, the attribute or the value is greater than a threshold. The one or more servers can apply the updated one or more rules to current network traffic. The one or more servers can determine that a difference between the effectiveness of the updated one or more rules and the effectiveness of the one or more rules is greater than a threshold. The one or more servers can provide for display a comparison of the effectiveness of the updated one or more rules and the effectiveness of the one or more rules.

In some aspects, the present solution can relate to a system. The system can include one or more processors coupled to memory. The one or more processors can be configured to establish one or more rules for security of a network environment. Each of the one or more rules can identify an entity, an attribute of the entity and a value of the attribute. The one or more processors can detect, responsive to monitoring the network environment, a change in one of the entity, the attribute or the value. The one or more processors can generate, responsive to the detection, an updated one or more rules for security of the network environment based at least on the change. The one or more processors can apply the updated one or more rules to previous network traffic to which the one or more rules were applied. The one or more processors can determine that an effectiveness of the updated one or more rules is greater than effectiveness of the one or more rules. The one or more processors can provide, responsive to the determination, a recommendation to use the updated one or more rules.

The one or more processors can detect the change in one of the entity, the attribute or the value based on a comparison of an updated state of one of the entity, the attribute or the value and a prior state of the one of the entity, the attribute or the value. The one or more processors can monitor a value graph corresponding to the network environment, the value graph comprising a representation of the network environment using the entity, the attribute and the value. The one or more processors can detect the change in one of the entity, the attribute or the value in the value graph.

The one or more processors can generate the updated one or more rules using at least one of the entity or the attribute of the one or more rules. The one or more processors can generate the updated one or more rules responsive to detecting that the change in one of the entity, the attribute or the value is greater than a threshold. The one or more processors can apply the updated one or more rules to current network traffic. The one or more processors can determine that a difference between the effectiveness of the updated one or more rules and the effectiveness of the one or more rules is greater than a threshold. The one or more processors can provide for display a comparison of the effectiveness of the updated one or more rules and the effectiveness of the one or more rules.

In some aspects, the present solution can relate to a non-transitory computer readable medium. The non-transitory computer readable medium can store program instructions. The program instructions can cause at least one processor of one or more servers to establish one or more rules for security of a network environment. Each of the one or more rules can identify an entity, an attribute of the entity and a value of the attribute. The program instructions can cause the at least one processor to detect, responsive to monitoring the network environment, a change in one of the entity, the attribute or the value. The program instructions can cause the at least one processor to generate, responsive to the detection, an updated one or more rules for security of the network environment based at least on the change. The program instructions can cause the at least one processor to apply the updated one or more rules to previous network traffic to which the one or more rules were applied. The program instructions can cause the at least one processor to determine that an effectiveness of the updated one or more rules is greater than effectiveness of the one or more rules. The program instructions can cause the at least one processor to provide, responsive to the determination, a recommendation to use the updated one or more rules.

The program instructions can cause at least one processor of the one or more servers to detect the change in one of the entity, the attribute or the value based on a comparison of an updated state of one of the entity, the attribute or the value and a prior state of the one of the entity, the attribute or the value. The program instructions can cause the at least one processor to generate the updated one or more rules using at least one of the entity or the attribute of the one or more rules. The program instructions can cause at least one processor of the one or more servers to provide for display of a comparison of the effectiveness of the updated one or more rules and the effectiveness of the one or more rules.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of a network device, such as a server providing content or an appliance for processing communications between a client and a server, in accordance with an illustrative embodiment;

FIG. 3 includes a block diagram of an example system for generating and recommending updated network security rules based on changes in the network data, in accordance with an illustrative embodiment;

FIG. 4A includes an example diagram of an entity graph generated by the system for generating and recommending updated network security rules, in accordance with an illustrative embodiment;

FIG. 4B includes an example diagram of an implementation of rules of the system in the present solution creating relations between various rule entities, in accordance with an illustrative embodiment.

FIG. 5 includes a graph of trigger estimate change plots for an original rule and an updated rule generated in accordance with an embodiment of the present solution;

FIG. 6 includes an example of a graphical user interface window of a recommended updated rule along with its performance, generated in accordance with an embodiment of the present solution;

FIG. 7 includes another example of a graphical user interface window of a recommended updated rule along with its performance, generated in accordance with an embodiment of the present solution;

FIG. 8 includes a flow diagram of an example method of generating and recommending updated rules based on changes in the network data, in accordance with an illustrative embodiment;

FIG. 9 includes a flow diagram of an example process, implemented by the system of the present solution, of generating and recommending updated rules based on changes in the network data, in accordance with an illustrative embodiment.

### DETAILED DESCRIPTION

Tools for network security and analytics can offer different features to help administrators convert security triage steps for managing network into rules. Once established, these rules can be applied to the network ecosystem in accordance with their defined settings. Defining a rule can involve use of telemetry data having various thresholds, values, and conditions. Although the rules can be updated over time to incorporate new data or update new policies, manually updating network rules can be time consuming and inefficient. As new devices, software and products are introduced or modified on the network, the network ecosystem can continuously change over time, which can adversely affect the effectiveness of the network rules made prior to the changes.

To improve the effectiveness of the network rules and account to the changes to the network ecosystem, the present solution provides systems and methods to continuously monitor new data and take advantage of the new attributes identified in the telemetry to create updated rules. The updated rules can be evaluated to ensure that their effectiveness exceed the effectiveness of the older rules they are to replace. When the effectiveness of the updated rule exceeds that of the prior rule, the present solution provides a recommendation to the administrators to use the updated rule, thereby helping the administrator maintain the high effectiveness of the network security rules despite the changes to the network ecosystem.

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods recommending updated rules based on changes in network data

### A. Network and Computing Environment

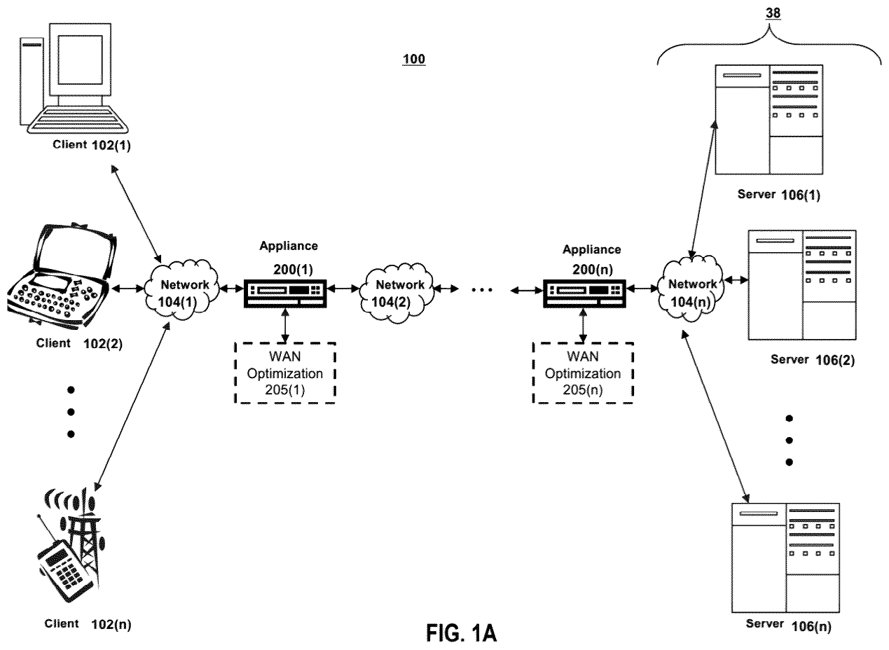

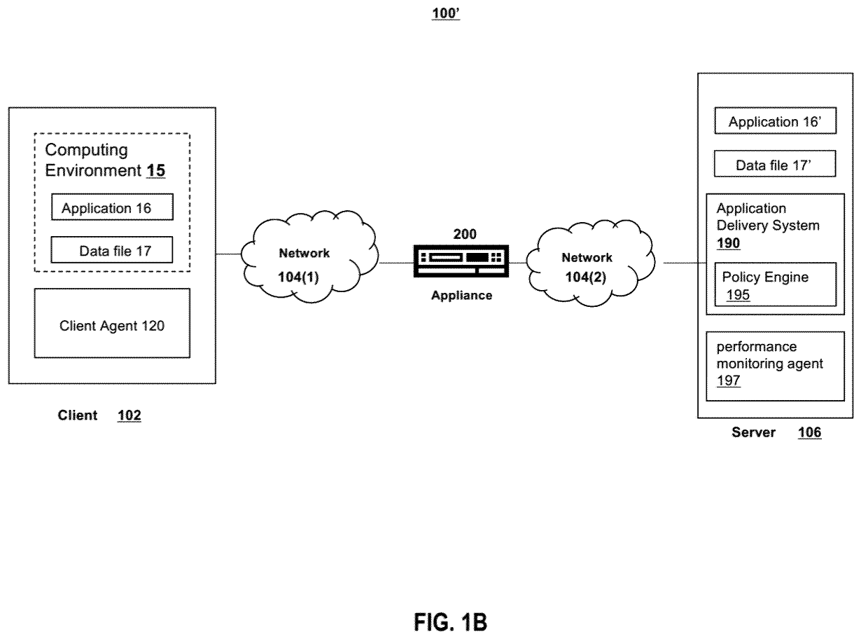

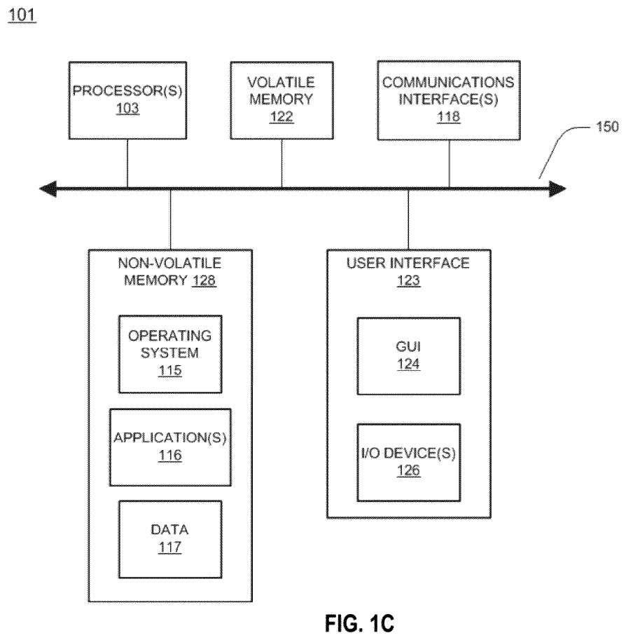

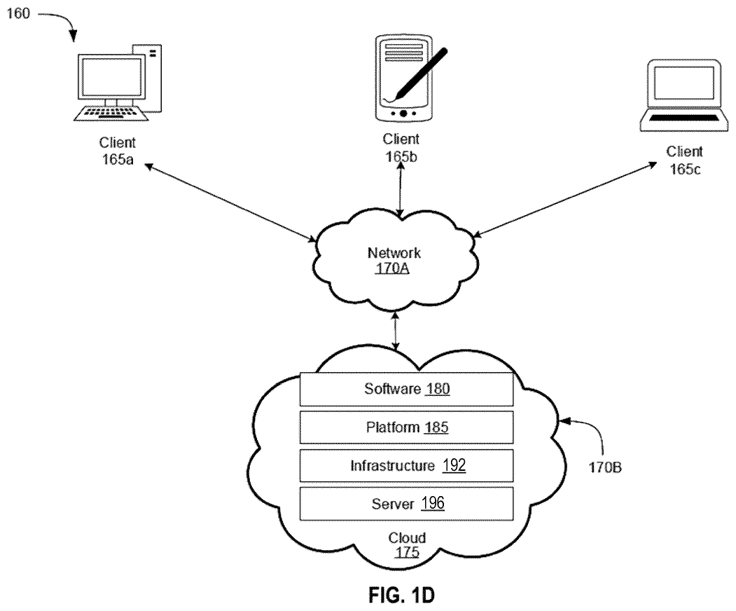

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, FL, the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 196, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 can include any functionality or features of clients 102 and vice versa. Clients 165 may include, e.g., thick clients, thin clients, and zero clients. The cloud 175 may include back end platforms, e.g., servers 196, storage, and server farms or data centers. Clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 196 that are maintained by third parties to clients 165 or the owners of the clients 165. The servers 196 may be located off-site in remote geographical locations as disclosed above or otherwise. Public clouds 175 may be connected to the servers 196 over a public network 170. Private clouds 175 may include private servers 196 that are physically maintained by clients 165 or owners of clients 165. Private clouds 175 may be connected to the servers 196 over a private network 170. Hybrid clouds 175 may include both the private and public networks 170A, 170B and servers 196.

The cloud 175 may include back end platforms, e.g., servers 196, storage, server farms or data centers. For example, the cloud 175 can include or correspond to a server 196 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 192. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

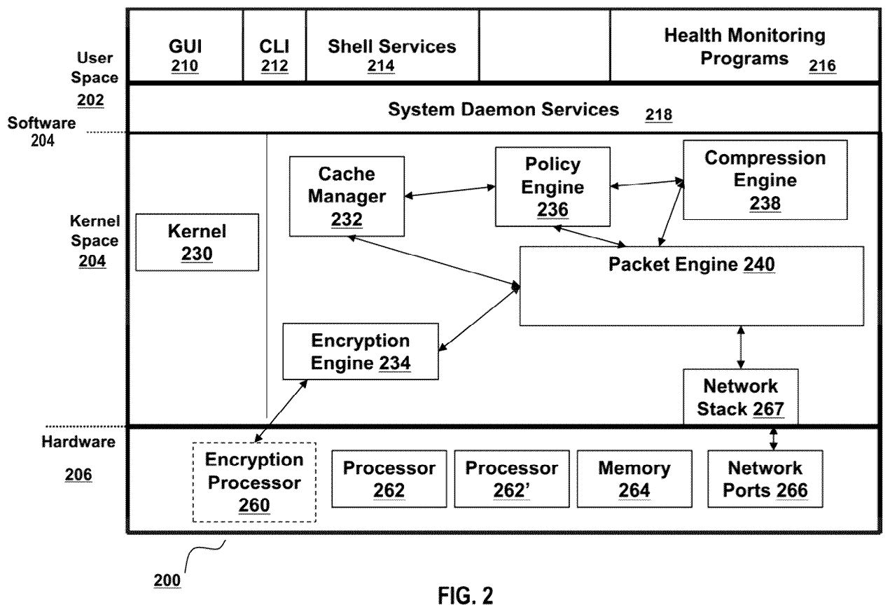

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 204 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, FL, the teachings of which are hereby incorporated herein by reference.

### C. Recommending Updated Rules Based on Changes in Network Data

Network security tools, such as for example the Citrix Analytics for Security by Citrix Systems, Inc., can provide features for turning network security triage steps into rules for automated network security. These rules can improve the network security by operating autonomously in accordance with their configuration. As the configuration of a network rule may need to be updated over time, the systems and methods of the present solution can monitor the network data to identify changes in the data (e.g., rule entities, attributes and values), based on which an updated rule can be generated. Once generated, the present solution can compare the effectiveness of the updated rule against the effectiveness of the prior (e.g., original) rule which the updated rule is meant to replace. If the effectiveness of the updated rule exceeds that of the prior rule, the present solution can issue a recommendation to the administrator to replace the prior rule with the updated rule. In doing so, the present solution can take advantage of the changes in the network data (e.g., rule entities, attributes and values) to improve the effectiveness of the rules used for the network security and account for the evolution of the network ecosystem.

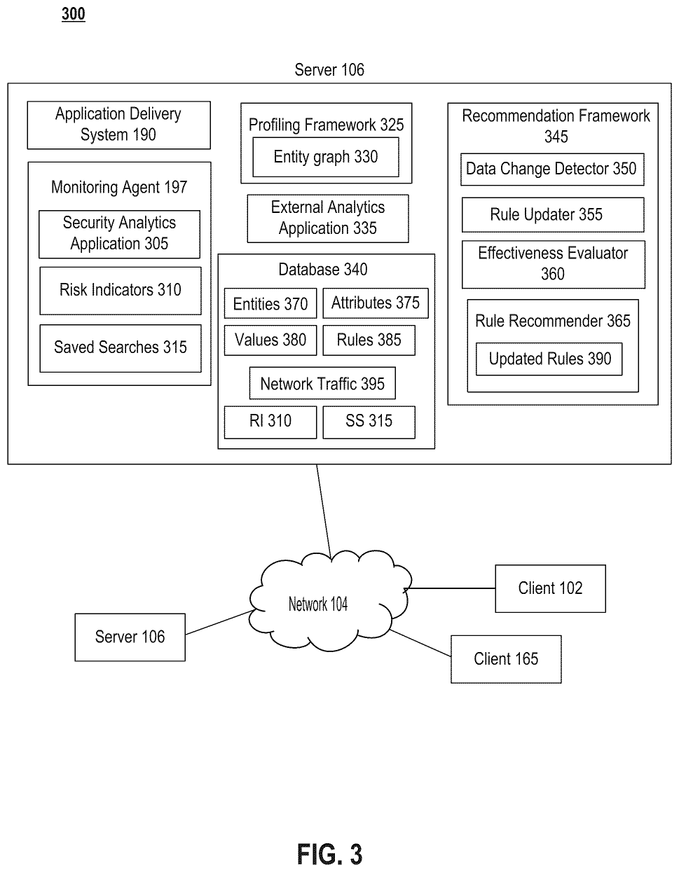

Referring now to FIG. 3, a system 300 for generating and recommending updated network security rules based on changes in the network data is illustrated. In brief overview, system 300 can include one or more servers 106 that can include one or more application delivery systems 190, monitoring agents 197, profiling frameworks 325, external analytics applications 335, databases 340 and recommendation frameworks 345. Monitoring agent 197 and their security analytics applications 305 can provide risk indicators (RI) 310 and saved searches (SS) 315 pertaining to various entities. Profiling network 325 can identify new, changed or otherwise updated data on the network and generate an entity graph 330 (e.g., value graph) for one or more entities on the network ecosystem, such as any clients 102 or 165, or any other devices, users and sessions on the network 104. The new, changed or updated data gathered by the system 300 can include entities 370, attributes 375, values 380 of various rules 385 and can be found in the network traffic, which along with RI 310 and SS 315 can be stored in a database 340. The recommendation framework 345 can include a data change detector 350, rule updater 355, effectiveness evaluator 360 and rule recommender. The data change detector 350 can identify changes in the data (e.g., entities 370, attributes 375 or values 380). The rule updater 355 can generate updated rules 385 using the new or updated data. The effectiveness evaluator 360 can determine whether the effectiveness of the updated rules 390 generated using the updated data is improved over the effectiveness of the prior (e.g., existing) rules 385. Rule recommender 365 can provide updated rules 390 to the administrator with a recommendation to use the updated rule 390 instead of the prior or existing rule 385 due to its improved effectiveness.

Application delivery system 190 can provide any number of applications to the clients 102 or 165 on the network ecosystem 104. Application delivery system 190 can provide, for example, virtual or desktop applications, mobile device applications, desktop application, remote access applications or any other applications that can be run on any client 102 or 106 on the network 104. Application delivery system 190 can provide, for example Citrix Workspace Suite™ by Citrix Systems, Inc., which can be operating within or used by any sessions, clients 102 or 165 or servers 106.

Monitoring agent 197 can monitor and gather data, including telemetry on the network ecosystem 104 and provide application performance management for application delivery system 190. For example, monitoring agent 197 can gather data and monitor the performance of the applications provided by the application delivery system 190 and gather information, metrics or metadata associated with entities 370, their attributes 375 and values 380. Monitoring agent 197 can implement rules 385 or updated rules 390. Monitoring agent 197 can apply rules 385 or 390 to the network traffic to implement network security actions, services or activities. Monitoring agent 197 can provide any features of the Citrix Analytics for Security by Citrix Systems, Inc.

Security analytics application (SAA) 305 can include any application for monitoring network environment and providing network security services. SAA 305 can include programs, functions, computer code or functions implemented in processors, such as 260 and 262, for monitoring network security data or network traffic, identifying network security threats, or identifying malicious user or network device behavior. SAA 305 can provide any number of functions or services for improving network security. For example SAA 305 can provide one or more antivirus applications or services, one or more firewall applications, a real-time network monitoring and threat analysis, a risk analysis for network entities 370, or data security functions. SAA 305 can aggregate and correlate network data to identify suspicious or malicious network activity. SAA 305 can process network data and generate metadata for identifying suspicious actors, nodes or activities. SAA 305 can in include Citrix Analytics for Security by Citrix Systems, Inc.

Risk indicators (RI) 310 can include any information indicating risk associated with an entity 370 on a network 104. Risk indicator 310 can include an indication of user risk activities that look suspicious or can pose a security threat to an organization. Risk indicator 310 can indicate severity or risk level. Risk indicator 310 can include information on a user or a device. Risk indicator 310 can identify user or device actions, data source, user information. Risk indicator 310 can identify the risk category and the status of the risk indicator 310. Risk indicator 310 can identify any number of policies associated with the risk or any number of rules, such as rules 385 or 390 to be applied.

RI 310 can be customized for a particular entity 370. RI 310 can be created, modified and deleted manually by the administrators. RI 310 can be pre-configured custom risk indicators. RI 310 can include or identify a data source, which can indicate the data source on which the RI 310 should be executed. RI 310 can include a query to indicate the conditions defined in the template. The query can retrieve the user events that satisfy the conditions. RI 310 can include the description to indicate the purpose of the query. RI 310 can include the frequency to indicate the frequency at which the query triggers. For example, there can be risk categories associated with the events searched by the query. Risk categories can include, for example, data exfiltration, insider threats, compromised users and comprise end points. RI 310 can include the severity indicator to indicate the severity of the risk associated with the event. The risk severity can be high, medium, or low.

Saved searches 315 can include any information on prior saved searches or queries associated with risk indicators 310. Saved searches 315 can include any information on the security threats, severity of the threats, users, devices or end points involved or any other information that can be included in the RI 310. Saved searches can include information on queries involving network entities 370 identified in risk indicators 310.

Profiling framework 325 can include any combination of hardware and software for profiling of data on a network ecosystem. Profiling framework can include programs, functions, computer code or functions implemented in processors, such as 260 and 262, for performing data profiling. Profiling framework 325 can include the functionality for gathering data, processing data, analyzing data, identifying related or correlated information about entities 370, identifying or generating metadata, identifying telemetry, updated data and creating data profiles for entities 370.

Profiling framework 325 can include and utilize machine learning platforms or functions. For instance, profiling framework 325 can include or use a machine learning (ML) model or an artificial intelligence (AI) model to make any determinations regarding data profiling, entity graph 330 generation or identifying information for any entity 370 on a network ecosystem. Profiling framework 325 can utilize any AI or ML technique, including, for example, supervised learning, unsupervised learning or reinforcement learning. Profiling framework 325 can include or use functions utilizing linear regression, logistic regression, a decision tree, support vector machine, Naïve Bayes, k-nearest neighbor, k-means, random forest, dimensionality reduction function, or gradient boosting functions. Profiling framework 325 can any functionality for training an ML or AI a function or a model to generate entity graphs 330 based on any data traversing the network ecosystem, including any data stored in database 340.

Data profiling framework 325 can include the functionality for implementing a data profiling process. Data profiling process can include calculating or visualizing a series of data, including statistics and metadata (e.g., data for data). Data profiling process can allow better understanding the dataset and how its features behave both with respect to themselves and with respect to other features. Data profiling process can allow for discovering of the data quality aspects. There can be different types of data profiling. For example, column profiling (e.g., attribute analysis) can aim at discovering both general and detailed information about the structure and content of data stored within a given column or attribute. Attribute analysis can look for information involving patterns, domains, data types, and unique values. For example, cross-column profiling (e.g., functional dependency) can help reveal information about column/attribute relationships. For example, cross-data source profiling (e.g., referential analysis) can involve detecting aspects of data objects (datasets) that refer to other objects (datasets). Referential analysis can provide insights into how the object being profiled is related or connected to other objects.

Data profiling can offer multiple insights into data. For example outcome of profiling of the Operating System “OS” of an entity 370 can be used to identify any type of metadata. For example, metadata can relate to attributes 375 and can include the type of the operating system used on a network device, the version of the operating system used, the memory size of the device, or any other information that can be used for generating the entity graph 330.

Entity graph 330, also referred to as a value graph 330, can include any representation of one or more network entities 370 on a network ecosystem 104 generated from the profiled data by the profiling. Entity graph 330 can include a graphical representation of an entity 370. Entity graph 330 can include a mapping of the state of the network devices, users, operating systems, applications used or any other information pertaining to the network security that can be extracted from the telemetry data gathered from the network ecosystem. Entity graph 330 can identify users or customers utilizing network devices, such as clients 102, and identify network locations they accessed, systems, tools or operating systems they used, and so on. Entity graph 330 can identify relations or connections between different entities 370 and attributes 375 on the network. For example, entity graph 330 can identify which user (e.g., customer) accessed which device, and further identify the operating system involved, a network IP address range involved, used or accessed, as well as any other information related to the network communication of the given user, network device, or a system.

Entity graph 330 (e.g., value graph) can include captured values and data that entity 370 and its attributes 375 can take along with additional profiling metadata (e.g., data from security analytics applications 305) and other metadata collected from external service providers associated with the entities (e.g., external analytics applications 335). Entity graph 330 can be generated from, or include, any number of nodes. A node can correspond to an entity 370, an attribute 375 or a combination of entity 370 and attribute(s) 375. An example node can include the information included, for example in the below table:

| Metadata | Description |
|---|---|
| data | Information that the node holds, such as entity value |
| | or attribute value |
| Profiling data | Unique profiling values |
| date created | Date on which the node was created |
| parent-node | Identifies the parent node |
| last-modified | Date when the node was modified |
| #child-relations | Number of child nodes |
| last-modified- | Last date when #child-relations was changed |
| #child-relations | |
| #parent-relations | Number of parent relations |
| last-modified- | Last date when #parent-relations was changed |
| #parent-relations | |
| Threat category | Insider threat, Compromised User, and so on |
| Profiling Stats | A child node or just as data attribute in the current |
| | node itself |
| Profiling match | For external data source as part of profiling an |
| | additional metric of match us calculated to estimate |
| | its presence is telemetry |

External analytics 335 can include any applications from third parties to monitor network environment and provide network security services. External analytics 335 can include programs, functions, computer code or functions implemented in processors, such as 260 and 262, for monitoring network security data or network traffic, identifying network security threats, or identifying malicious user or network device behavior to improve improving network security. External analytics 335 can provide data on user behavior, device updates, operating systems and other changes on the network that can correspond to entities 370, attributes 375 and values 380 of any of the rules 385 or updated rules 390. External analytics 335 can include any functionality of a security analytics application 305.

Database 340 can include can include any organized collection of structured information or data stored in memory, such as memory 264. Database 340 can include a file system and/or tables of information for storing data. Database 340 can store any information or metadata on connections between clients 102 and servers 106, or any other devices on the network 104. Database 340 can store any information, including data, telemetry or metadata, captured, detected or generated, with respect to any entity 370, attribute 375, value 380, rules 385, network traffic 395, risk indicator 310 or saved search 315. Database 340 can store a copy of, or any information or metadata related to, an entity 370, attribute 375, value 380, rule 385, network traffic 395, RI 310 or SS 315. Database 340 can include any information stored so as to be accessible for processing by any of the features of the server 106, such as the profiling framework 325, monitoring agent 197, or recommendation framework 345.

Entity 370 can be, or include, any one or more components of a network ecosystem. For example, entity 370 can be, or include, any one or more of devices (e.g., clients 102, 106), users, operating systems (e.g., android, iOS, Windows), network ranges (e.g., IP addresses on a network), network, such as network 104, applications, sessions, connections or any other components of a network 104. Entity 370 can include a network device used by one or more users. Entity 370 can include a network ecosystem. For example, entity 370 can include a set of devices that can be operated by a number of users utilizing a number of operating systems and applications on the devices and where the devices are interconnected, via a network 104, using established connections and sessions. Entity 370 can include a user on a network. Entity 370 can include a connection between devices. Entity 370 can include a session, such as a device or a user session.

Attribute 375 can include any data or information about the entity 370. Attribute 375 can include metadata about entity 370. Attribute 375 can include settings or definitions of entity 370 or an aspect of entity 370. For example, when entity 370 is a network, attribute 375 can include metadata for the network entity 370, describing the network entity 370. For example, attribute 375 can identify the kind of network entity 370 (e.g., ‘network-kind’) and can set it to “corporate”, or “external.” For example, attribute 375 can identify the network range of the network entity 370 (e.g., subnet details) and identify a range of IP addresses on the network entity 370. For example, attribute 375 can identify the network type and define the type, such as, “VPN” (e.g., virtual private network), or “Tor” (e.g., The Onion Router). Attribute 375 can define any features of the network entity 370. For example, attribute 375 for a user entity 370 can identify the user type, user access, user rank and similar. For example, attribute 375 for a device entity 370 can define the type of device and the operating system of the device.

Value 380 can include any one or more values, characters, settings or descriptions to define, specify or describe entities 370 and attributes 375. Value 380 can include one or more numerical values identifying a range of IP addresses on a network. Value 380 can include one or more characters an attribute 375 for the network entity 370. For example, when an attribute 375 for a network kind is defined, value 380 can include “corporate”, or “external” to define the attribute 375. Value 380 can include one or more characters an attribute 375 for the network type 370. For example, when an attribute 375 for a network type is defined, value 380 can include “VPN”, or “Tor” to define the attribute 375. Value 380 can include one or more characters identifying a user on a device on the network 104, or associated with an attribute 375 of a device on the network 104. Value 380 can include one or more characters identifying a parent node or a child node on an entity graph 330.

Rules 385 can include any rules for controlling network traffic. Rules 385 can include access controls for particular users, devices or services. Rules 385 can allow or deny inbound or outbound network traffics to or from several resources on the network 104. Rules 385 can include conditions. When conditions are met, rules 385 can trigger an alert or a command to take action. The action can include stopping of a network traffic, shutting down a service, an application, a network, a connection or a session. The action can be directed to a user, a device, network or a service. For example rules 385 can control the network traffic, in inbound or outbound direction, with respect to virtual or other networks, particular one or more users, devices or services on the network 104.

Rules 385 can be defined based on telemetry or network data including entities 370, attributes 375 and values 380. A rule 385 can be defined for an entity 370 using one or more attributes 375 and values 380 to define the attributes 375. For example, rule 385 can relate to a network entity 370, and an attribute 375 for network type can include value 380 identifying “Tor” as the network type. For example, rule 385 can relate to a device entity 370, and an attribute 375 for operating system can include a value 380 for defining operating system as “Android.” Similarly, rules 385 can relate to any type of entity 370 and attributes 375 can define or specify the entity, where the attributes 375 can be further specified or defined by values 380.

Rules 385 can be generated based on risk indicators 310 or saved searches 315. For example, RI 310 and/or saved searches 315 can identify particular conditions, users, entities 370, attributes 375 or values 380 for which a rule 385 is to be triggered. Rules 385 can include the data from the RI 310 or SS 315. Rules 385 can be generated in response to the RI 310 or SS 315. For example, a risk indicator for a particular device can identify the device on the network 104 as a high risk device (e.g., end note) and in response to the identification a rule 385 can be generated to take action when the high risk network device performs a suspicious or malicious activity.

Updated rules 390 can be any rules 385 updated using recommendation framework 345. Updated rules 390 can include any functionality of a rule 385. Updated rules 390 can be based on rules 385. Updated rules 390 can include or relate to entities 370, that can be further defined or specified by attributes 375, which can be further defined or specified by values 380. Updated rule 390 can be generated based on a particular rule 385 and can include the same one or more entities 370, attributes 375 and/or values 380 as the original rule on which it is based. Updated rule 390 can include a change, an edit or a modification to the original rule 385. The modification or change can include a change to any one or more of the entity 370, attribute 375 or value 380. For example, the modification or change can include a change to a network type (e.g., attribute 375) where value 380 for the network type 375 can include “VPN” instead of “Tor” to redefine the attribute 375 for the network type.

Network traffic 395 can include any traffic traversing network 104 or network ecosystem. Network traffic 395 can include network traffic between network devices (e.g., traffics between the clients 102 or 165 and servers 106). Network traffic 395 can include data or information exchanged on the network 104. Network traffic 395 can include network communications, such as communications via communication protocols, such as TCP/IP. Network traffic 395 can include historical data captured over a period of time, such as over a prior year, prior six months, prior month, prior two weeks, prior week, prior day or prior one or more hours. Network traffic 395 can include real-time data captured presently. Network traffic 395 can be stored in memory storage (e.g., 265) or in a database 340 and can be accessed by the recommendation framework 345 to evaluate the updated rules 390.

Recommendation framework 345 can include any combination of hardware and software to generate update rules 390, determine their effectiveness with respect to the original (e.g., prior) corresponding rules 385 and recommends the updated rules 390 to the administrator. Recommendation framework 345 can label definitions of rule 385 (or 390) using entity 370, attributes 375 and/or values 380. Recommendation framework 345 can therefore define rules 385 and updated rules 390 in terms of entities 370, attributes 375 and values 380. Recommendation framework 345 can include scrips, computer code, functions or instructions stored in memory (e.g., 122 or 265) and executed by processors 260 or 262. Recommendation framework 345 can include the functionality to monitor network traffic and identify changes (e.g., using data change detector 350). Recommendation framework 345 can include the functionality to update rules 385 into updated rules 390 using rule updater 355. Recommendation framework 345 can include the functionality to evaluate effectiveness of the updated rules 390 (e.g., using effectiveness evaluator 360). Recommendation framework 345 can include the functionality to recommend updated rules 390 to the network administrator (e.g., using rule recommender 365).

Data change detector 350 can include any scripts, computer code, functions or instructions stored in memory (e.g., 122, 265) and executed by processors (e.g., 260, 262) to detect changes in network data. Data change detector 350 can include the functionality to monitor the network traffic and identify changes in the data or traffic traversing the network 104. Data change detector 350 can identify changes in data that pertain to an existing rule 385. Data change detector 350 can capture and store the new data reflecting the change. The data reflecting the change can be captured, for example, as a portion of network traffic 395. Data change detector 350 can identify changes or updates in the data. For example, data change detector 350 can identify a new operating system being used by a device on a network. For example, data change detector 350 can identify a new user on a network. For example, data change detector 350 can identify a new set of IP addresses being accessed by a device or a user. Data change detector 350 can capture and store the new data reflecting the change. The data reflecting the change can be captured, for example, as a portion of network traffic 395 or stored in a memory in connection with the recommendation framework 345 (e.g., storage 264).

Rule updater 355 can include any scripts, computer code, functions or instructions stored in memory (e.g., 122, 265) and executed by processors (e.g., 260, 262) to generate new or updated rules 390. Rule updater 355 can include the functionality to identify an existing rule 385 that relates to the changed data identified by the data change detector 350. Rule updater 355 can include the functionality to use the changed data identified by the change detector 350 to generate an updated rule 390. Rule updater 355 can include the functionality to identify an existing rule 385 for which, or based on which, to generate an updated rule 390. Rule updater 355 can include the functionality to update the original rule 385 using the changed data identified by the data change detector 350. Rule updater 355 can include the functionality to generate the updated rule 390 by modifying the corresponding original rule 385 using the changed data identified by the data change detector 350.

Effectiveness evaluator 360 can include any scripts, computer code, functions or instructions stored in memory (e.g., 122, 265) and executed by processors (e.g., 260, 262) to evaluate effectiveness or efficiency of updated rules 390. Effectiveness evaluator 360 can include the functionality to identify the effectiveness or efficiency of an original rule 385 and the effectiveness or efficiency of the updated rule 390 that is based on, or replaces, the original rule 385. Effectiveness evaluator 360 can compare the effectiveness or efficiency of the updated rule 390 with the current effectiveness or efficiency of the original rule 385. The current effectiveness or efficiency of the original rule 385 can be lower than the original effectiveness or efficiency of the rule 385 when it was originally created. Effectiveness evaluator 360 can include the functionality to compare the effectiveness or efficiency of the updated rule 390 with its corresponding original rule 385 (e.g., the rule that updated rule 390 is to replace). Effectiveness evaluator 360 can include the functionality to determine whether the effectiveness or efficiency of the updated rule 390 is greater than the effectiveness or efficiency of the original rule 385 by a predetermined amount, such as a predetermined threshold.

Effectiveness evaluator 360 can determine the effectiveness of the updated rule 390 by testing the updated rule 390 on a data set. The data set can include historical data from the network 104 (e.g., network ecosystem) on which the rules 385 and updated rules 390 are deployed or used. The data set can include network traffic 395. Effectiveness evaluator 360 can receive an updated rule 390 from the rule updater 355 and run the updated rule 390 on a data set (e.g., network traffic 395) to determine the effectiveness or efficiency of the updated rule 390. Effectiveness evaluator 360 can also run the original rule 385 on the same data set (e.g., network traffic 395) to determine the present effectiveness or efficiency of the original rule 385 on which the updated rule 390 is based (e.g., and which the updated rule 390 is meant to replace). Effectiveness evaluator 360 can determine which of the updated rule 390 or the original rule 385 has the higher effectiveness or efficiency.

Rule recommender 365 can include any scripts, computer code, functions or instructions stored in memory (e.g., 122, 265) and executed by processors (e.g., 260, 262) to recommend updated rule 390. Rule recommender 365 can determine or identify that the updated rule 390 has higher effectiveness or efficiency than the original rule 385, which the updated rule 390 is to replace. Rule recommender 365 can determine or identify that the updated rule 390 is more effective or efficient than the corresponding original rule 385 by a predetermined threshold or margin. The predetermined threshold or margin can be anywhere between 1 and 10%, such as at least 1%, 2%, 3%, 4%, 5%, 6%, 7%, 8%, 9% or 10%, or more than 10%. For example, the rule recommender 365 can determine that the updated rule 390 has effectiveness or efficiency greater than that of the original rule 385 by more than 5%, and in response to this determination recommend the updated rule 390. For example, rule recommender 365 can determine that the updated rule 390 has effectiveness or efficiency that exceeds that of the original rule 385 by more than a threshold amount, in response to this determination, recommend the updated rule 390

The updated rule 390 can be recommended to an administrator. The updated rule 390 can be sent to a queue of updated rules 390 for the administrator to review and approve. The updated rule 390 can be recommended or sent to a system for implementing rules, such as a monitoring agent 197. For example, the updated rule 390, once identified as more effective or efficient, can be sent to the monitoring agent 197 and implemented by the monitoring agent 197, in response to being sent to the monitoring agent 197 by the rule recommender 365 (e.g., without any approval by the administrator).

The present solution can leverage a machine learning platform on a profiling framework 345 for profiling or monitoring data in order to continuously build a profiled entity graph 330. The entity graph 330 (e.g., value graph) can be built or constructed for each entity 370, such as a device, a user, a session or a network. Attributes 375 for the entities 370, such as those involving metadata, can be used to help describe, define or characterize the entities 370. For example, when dealing with a entity 370 that is “network”, entity attributes 375 for this entity 370 can include various descriptors, such as for example a “network-kind,” which can be set to ‘corporate’ or ‘external’ (e.g., value 380) to identify the kind of the network entity 370.

The present solution can label definitions of rules 385 or updated rules 390 using entities 370, attributes 375 and any corresponding attribute values 380. As the solution determines a change in value graph 330, such as a change in the new data adding new attributes 375 or removing unnecessary attributes 375, the present solution can process the change using the recommendation framework 345 and created updated rules 390 to recommend. The updated rules 390 can reflect the rule definition changes with respect to the corresponding original rules 385. As a result, improved performance in the effectiveness of the updated rules 390 can be determined by effectiveness evaluator 360 by comparing the performance (e.g., effectiveness) of the updated rules 390 with the performance (e.g., effectiveness) of the original rules 385.

As an example, the system 300 of the present solution can include a server 106 having one or more processors (e.g., 103, 260 or 262) are coupled to memory (e.g., memory 264, 122 or 128) and configured to perform any number of programmed tasks. The server 106 can establish one or more rules 385 for security of a network environment (e.g., 104). Each of the rules 385 can identify an entity 370, an attribute 375 of the entity and a value 380 of the attribute 375. The server 106 can detect, responsive to monitoring the network environment by the profiling framework 325, a change in one of the entity 370, the attribute 375 or the value 380. The server 106 can generate, responsive to the detection of the change, an updated one or more rules 390 for security of the network environment based at least on the change. The server 106 can apply the updated one or more rules 390 to previous network traffic 395 to which the one or more rules 385 were applied. The server 106 can determine that an effectiveness of the updated one or more rules 390 is greater than effectiveness of the one or more rules 385. The server 106 can provide, responsive to the determination, a recommendation to use the updated one or more rules 390.

The server 106 can detect the change in one of the entity 370, the attribute 375 or the value 380 based on a comparison of an updated state of one of the entity 370, the attribute 375 or the value 380 and a prior state of the one of the entity 370, the attribute 375 or the value 380. The server 106 can monitor, using a data change detector 350, a value graph 330 corresponding to the network environment 104. The value graph (e.g., entity graph 330) can include a representation of the network environment 104 using the entity 370, the attribute 375 and the value 380. The data change detector 350 can detect the change in one of the entity 370, the attribute 375 or the value 380 in the value graph 330.

The server 106 can generate, using the rule updater 355, the updated one or more rules 390 using at least one of the entity 370 or the attribute 375 of the one or more rules 385. The server 106 can generate the updated one or more rules 390 responsive to detecting that the change in one of the entity 370, the attribute 375 or the value 380 is greater than a threshold. The server 106 can apply the updated one or more rules 390 to current network traffic, such as the traffic traversing the network 104 in real-time. The server 106 can determine that a difference between the effectiveness of the updated one or more rules 390 and the effectiveness of the one or more rules 385 is greater than a threshold. In response to this determination, the effectiveness evaluator 360 or the rule recommender 365 can determine that the updated rule 390 is to be recommended. The server 106 can provide for display a comparison of the effectiveness of the updated one or more rules 390 and the effectiveness of the one or more rules 385.

As an example, the present solution can include a non-transitory computer readable medium (e.g., memory 264, 122 or 128) storing program instructions for causing at least one processor (e.g., 103, 260 or 262) of one or more servers 106 to perform any set of tasks. The program instructions can cause a processor to establish one or more rules 385 for security of a network environment 104. Each of the one or more rules 385 can identify an entity 370, an attribute 375 of the entity 370 and a value of the attribute 380. The program instructions can cause the processor to detect by data change detector 350, responsive to monitoring the network environment on network 104 by profiling framework 325, a change in one of the entity 370, the attribute 375 or the value 380. The program instructions can cause the processor to generate, responsive to the detection, an updated one or more rules 390 for security of the network environment 104 based at least on the change. The program instructions can cause the processor to apply the updated one or more rules 390 to previous network traffic 395 to which the one or more rules 385 were applied. The previous network traffic 395 can include network traffic traversing the network 104 over a prior period of time, such as one or more weeks or months to which the rules 385 were exposed during that period of time. The program instructions can cause the processor to determine, by the effectiveness evaluator 360, that an effectiveness of the updated one or more rules 390 is greater than effectiveness of the one or more rules 385. The program instructions can cause the processor to provide, responsive to the determination, a recommendation by the rule recommender 365 to use the updated one or more rules 390. The updated one or more rules 390 can be recommended to replace their corresponding prior one or more rules 385.

The program instructions can cause the processor to detect the change in one of the entity 370, the attribute 375 or the value 380 based on a comparison of an updated state of one of the entity 370, the attribute 375 or the value 380 and a prior state of the one of the entity 370, the attribute 375 or the value 380. The program instructions can cause the processor to generate the updated one or more rules 390 using at least one of the entity 370 or the attribute 375 of the one or more rules 385. The program instructions can cause the processor to provide for display a comparison of the effectiveness of the updated one or more rules 390 and the effectiveness of the one or more rules 385.

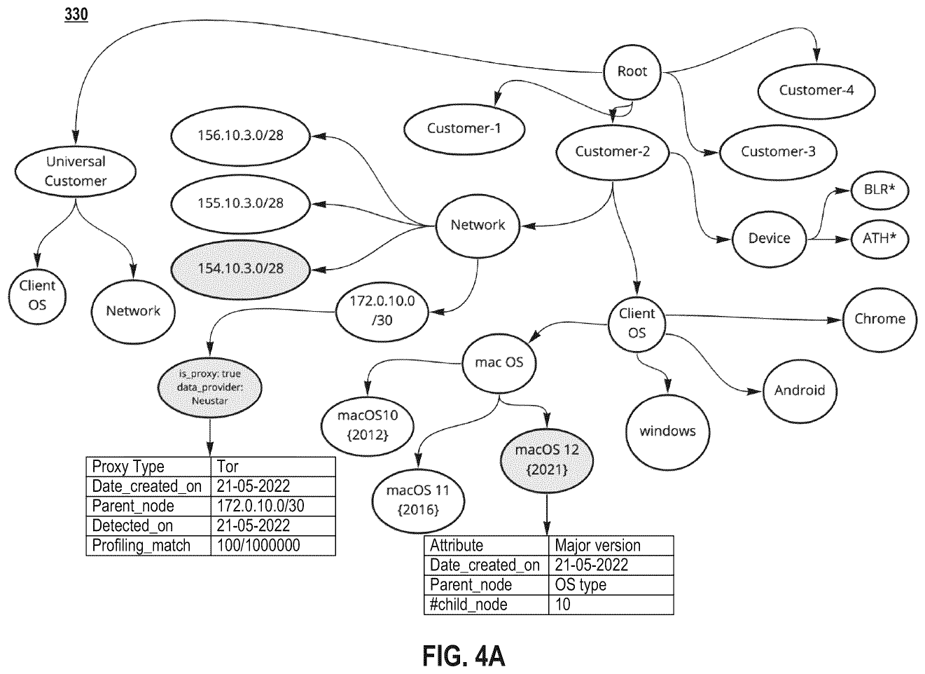

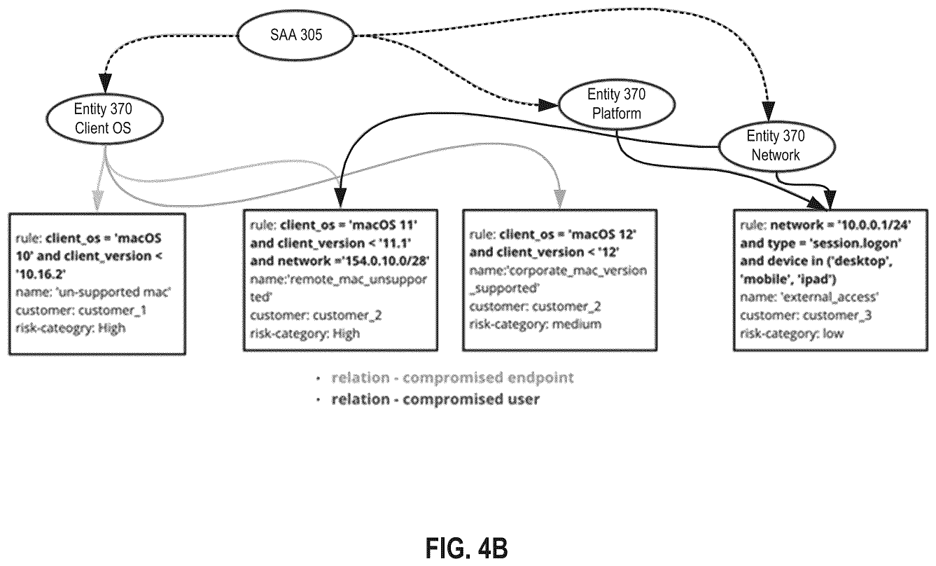

FIG. 4A illustrates an example an entity graph 330 (e.g., value graph). Entity graph 330 can include many interconnected nodes. A node can be represented by an oval/circular feature on the entity graph 330, which can be used to make decisions with respect to updated rules 390 to be generated. The entity graph 330 can represent a universal entity node, reflecting all of the nodes on a network. The value graph 330 can start from a “root” which can represent a starting point for the purposes of analyzing the system of an network environment. The next set of nodes (e.g., children) can refer to customers 1-4. The next set of nodes can refer to devices, client operating systems (OSs) and networks of the customers. The next set of nodes can refer to the features of the devices, such as types of OSs used (e.g., Android, Windows, Chrome, mac OS) or ranges of IPs or subnet masks on a network. The value graph 330 of the network can include color shading to represent data that has changed since the last update of the rules or the last analysis. The changed data can refer to the new data to be identified by the data change detector 350. For example, in the FIG. 4A, shaded data change includes network range change, network type discovery and change in a client OS version.

Tables can be used to expand onto the new data. For example, a node corresponding to new information can include a proxy type identified as “tor”, a date created on identified as “21-05-2022”, parent node (e.g., identifying the IP address of the parent node), detected on identified as “21-05-2022” and profiling match identifying 100/1000000. For example, a node corresponding to new information can include attribute (e.g., attribute 375) which can be identified as “major version”, data created on identified as “21-05-2022”, parent node, identified as “OS type” and “#child node” identified as “10.”

The tabular format data can be used to represent data of a node. For example, a data change detector 350 can detect a device value change when it observes certain values of a device, or associated with the device, that is not included in an existing rule 385 corresponding to the device. In such an example, the values from current rule 385 and values detected after the original rule 385 creation, can be considered for generating rule update 390.

Using the profiled entity graph 330, a universal customer node can be created to cumulate the entity 370, attributes 375 and their corresponding values 380 and rules 385. The current rules 385 can be applied and persisted. The universal node can be used to discover or generate new rules for a customer's network environment. The generated or discovered 385 rule can then be configured (e.g., updated) with appropriate values from customers profiled entity graph 330 and the updated (e.g., configured) rule 390 can be evaluated for performance (e.g., effectiveness) against the prior rule 385. If more effective, the updated rule 390 can be recommended and then persisted along with its updated metrics and metadata.

FIG. 4B illustrates an example of implementation or persisting of rules 385 by the system 300 to create relations between various entities 370 used in the rule creation. In the illustrated example, a security analytics application (SAA) 305 can in relation to a rule 385 monitor data relating entities 370, including entity 370 for client operating system (Client OS), entity 370 for platform and entity 370 for network. SAA 305 can create relations between the entities 370 as indicated by arrows. Dotted arrows between the SAA 305 can indicate the monitoring of the entities 370 by the SAA 305 in accordance with the present solution. Light colored arrows between the entities 370 (e.g., entity 370 for Client OS) and the corresponding tables corresponding to rules 385 can indicate relations based on a potentially compromised endpoint as identified by the SAA 305. Dark colored arrows between the entities 370 Platform and Network and the tables corresponding to rules 385 can indicate relations based on comprised user. As shown in the tables corresponding to the rules 385, rules can be based on entity 370 for client OS, and can include attributes 375 such as a “macOS 10”, “macOS 11”, or “macOS 12” and client versions of the OS, such as “10.16.2”, “11.1” and “12”. Rules 385 can also be based on entity 370 for network, and can include attributes 375, such as “type” and “device.” While persisting rules 385, SAA 305 can monitor the data involving these entities 370, attributes 375 and their values 380, identify and create relations between them and use the relations to identify changes in the data corresponding to the entities 370, attributes 375 and values 380.

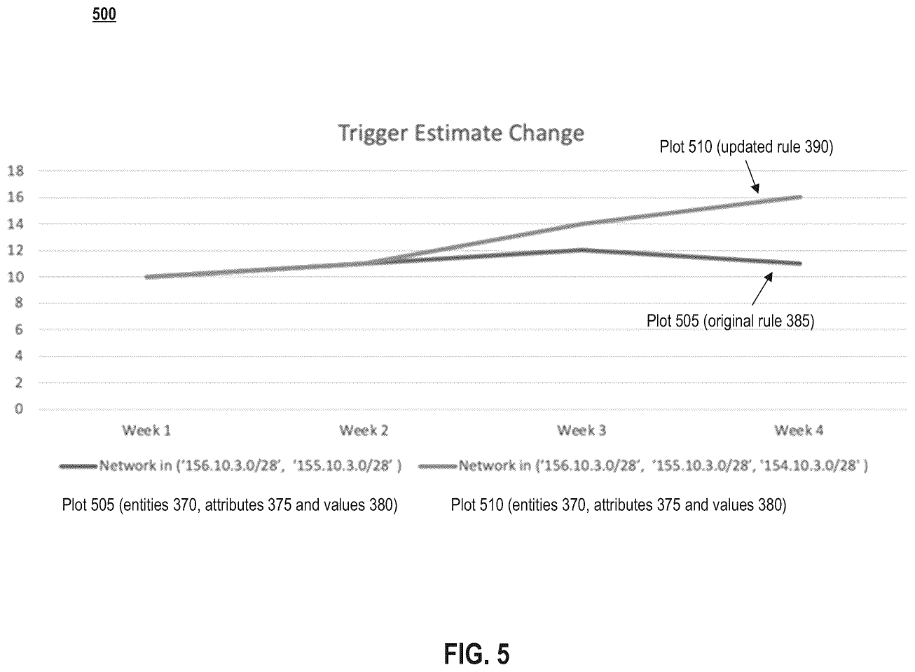

FIG. 5 refers to an example of a graph 500 of trigger estimate changes of a rules 385 and updated rules 390, as a function of time. FIG. 5 can relate to an action or a comparison between the updated rule 390 and original rule 385 that can be performed by the effectiveness evaluator 360. As changes to the network ecosystem occur over time, the unchanged rules 385 can lose their effectiveness with respect to the changed data. Updated rules 390 account for these changes and therefore can have improved performance when updated rules 390 include changes that improve the trigger performance of the rule.

Graph 500 shows a plot 505 of an original rule 385 alongside a plot 510 of an updated rule 390 for the same data set. The data set for each plot 505 and 510 can correspond to the network traffic 395. The network traffic 395 can include data on which rule 385 operated in real-time during the time period of that data traversing the network 104, whereas the updated rule 390 may have processed that same network traffic 395 when it was stored as historical data on the database 340. Each plot (e.g., 505 and 510) can reflect trigger estimates of the rule (e.g., 385 and 390) over a span of the time period of the network traffic 395 data set, such as the time period of four weeks. For example, plot 505 includes entities 370, attributes 375 and values 380 of the original rule 385, such as “Network in (‘156.10.3.0/28’, ‘155.10.3.0/28’).” Meanwhile, the plot 505 of the updated rule 390 can include entities 370, attributes 375 and values 380, such as “Network in (‘156.10.3.0/28’, ‘155.10.3.0/28’, and ‘154.10.3.0/28’).” Therefore, the new data (e.g., attributes 375 or values 380) added to the updated rule 390 includes the last network address in the row (e.g., 154.10.30.0/28), whereas the original rule 385 does not include this data in its attributes 375 and values 380.

Testing the two rules over the course of 4 weeks, we can see that plot 510 (e.g., updated rule 390) at week 2 begins to outperform plot 505 (e.g., rule 385). During weeks 3 and 4, plot 510 continues to outperform plot 505, showing that updated rule 390 outperforms rule 385. Based on the graph 500, it is clear that the updated rule 390 has the effectiveness (e.g., in terms of trigger change) that exceeds that of the original rule 385. Based on analysis such as the one illustrated in graph 500, effectiveness evaluator 360 can determine that the effectiveness of the updated rule 390 exceeds the effectiveness of the rule 385. Specifically, effectiveness evaluator 360 can simulate the trigger responses of the updated rule 390 and the original rule 385 and compare their performances in terms of triggers over time using a common data set. Effectiveness evaluator 360 can compare the trigger responses of the updated rule 390 performed on the last four weeks of data stored in network traffic 395 against the performance (e.g., triggers) from the rule 385 gathered over the past four weeks as rule 385 was being applied by the system.

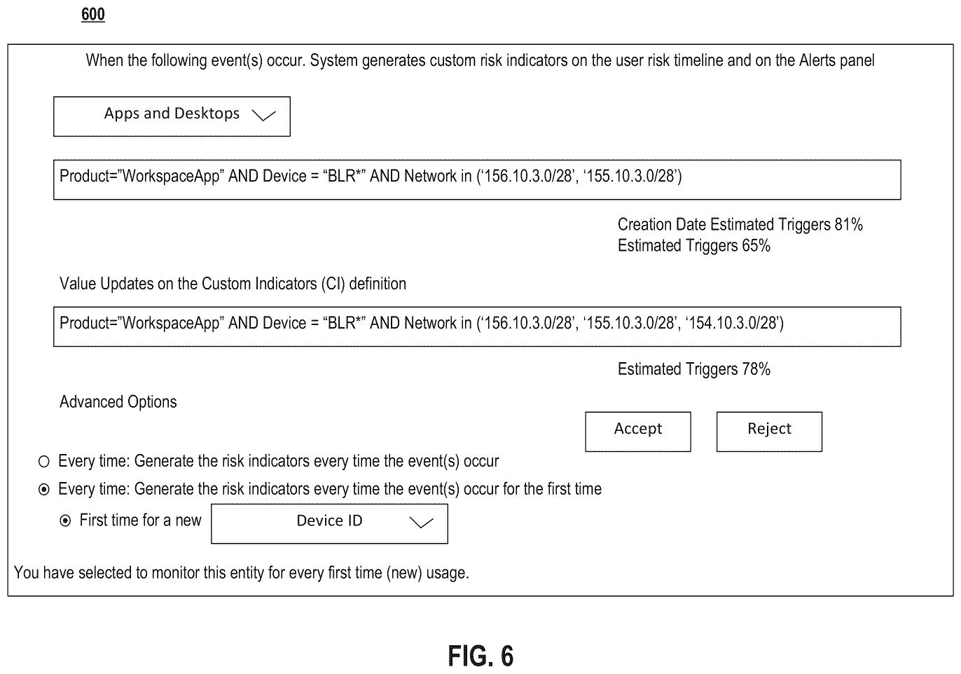

FIG. 6 illustrates an example of a graphical user interface window 600 for recommending an updated rule 390 based on the comparison of its performance with the performance of the original corresponding rule 385. For example, an administrator may have created a security rule 385 to monitor access from devices starting with name ‘BLR’ and from address ranges ‘156.10.3.0/28’ and ‘155.10.3.0/28’ on 21 Apr. 2022. When the rule is created the estimated trigger (success rule match) percentage was 81%. However, over time, the estimated trigger percentage has decreased due to the changes to the network ecosystem being made. As a result, the final (e.g., current) estimated trigger percentage is only 65%. Meanwhile, the updated rule 390 is created by the recommendation framework 345 using changed data (e.g., added third network address of “154.10.3.0/28”) resulting in the new estimated trigger percentage of 78%. In the illustrated example, the updated change refers to a new value 380 for an existing attribute 375, where the new value corresponds to a network address range. Since the 78% trigger percentage exceeds the trigger percentage of 65% by the original rule 385, the rule recommender 365 can issue the illustrated recommendation to the administrator to recommend replacing the rule 385 with the updated rule 390. Administrator can select between accepting and rejecting the recommendation. If accepted, the updated rule 390 can be used by the system instead of the prior rule 385.

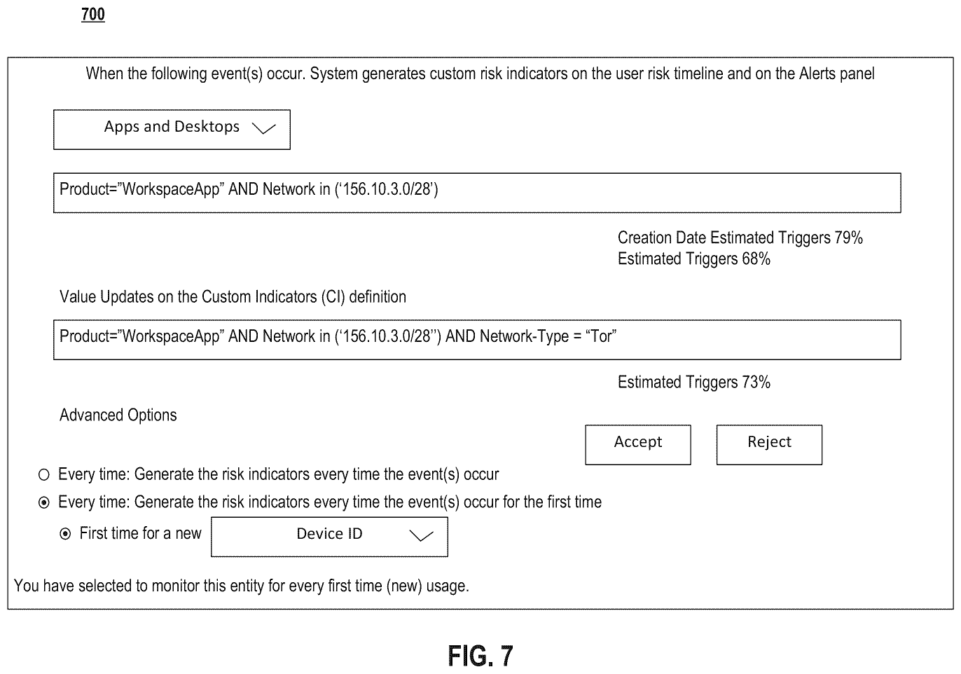

FIG. 7 illustrates another example of a graphical user interface window 700 for recommending an updated rule 390 based on the comparison of its performance with the performance of the original corresponding rule 385. For example, an administrator may have created a security rule 385 to monitor access from network range ‘156.10.30.0/28’ on 21 Apr. 2022. When the rule is created there was no network-type attribute 375 used and the estimated trigger (success rule match) percentage was 79%. However, over time, the estimated trigger percentage has decreased to the final (e.g., current) estimated trigger percentage is only 68%. Meanwhile, the updated rule 390 is created by the recommendation framework 345 using changed data (e.g., adding the attribute 375 of “network-type” to identify the value “Tor” in order to reflect the change in data where Tor network type was used). This resulted in the new estimated trigger percentage of 78%. In the illustrated example, the updated change refers to a new attribute 375 (e.g., network type) and new value 380 (e.g., tor) and since the 73% trigger percentage exceeds the trigger percentage of 68% by the original rule 385, the rule recommender 365 can issue the illustrated recommendation to the administrator to recommend replacing the rule 385 with the updated rule 390. Administrator can select between accepting and rejecting the recommendation. If accepted, the updated rule 390 can be used by the system instead of the prior rule 385.

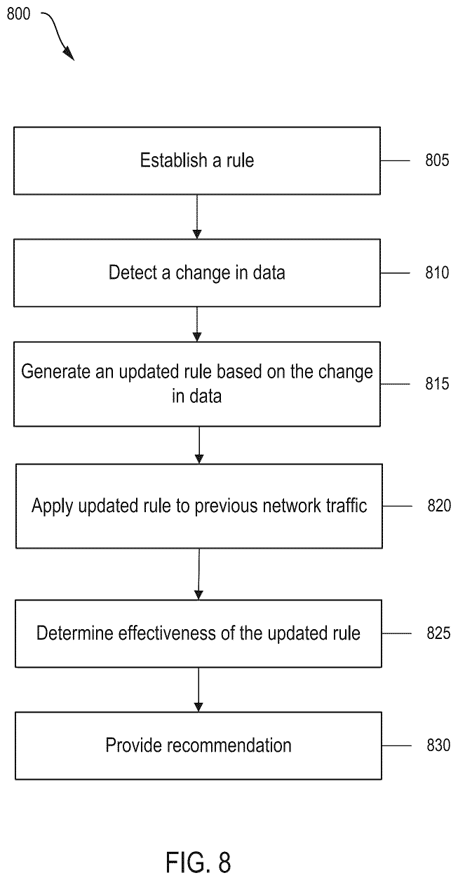

FIG. 8 illustrates a method 800 of generating and recommending updated network security rules based on changes in the network data. The method 800 can include acts 805-830. At act 805, the method establishes a rule. Act 810, the method detects a change in data. At act 815, the method generates an updated rule based on the change in data. At act 820, the method applies updated rule to previous network traffic. At act 825, the method determins effectiveness of the updated rule. At act 830, the method provides a recommendation.

At act 805, a server can establish a rule. One or more servers can establish one or more rules for security of a network environment. Each of the one or more rules can identify an entity, an attribute of the entity and a value of the attribute. An administrator can establish the rule. A network security application can establish the rule. The network security application can establish the rule based on an identified risk indicator of an entity or based on a saved search. The saved search can relate to an entity. The rule can be defined using any one or more of an entity, an attribute of the entity and a value for the attribute of the entity. The entity can include any one or more of a user, a device, a session, a network or a network ecosystem. The attribute can include any data or metadata about the entity, such as data or metadata describing, qualifying, identifying or specifying the entity. The value can include any one or more values, characters, strings of characters of definitions specifying, identifying or describing or qualifying an attribute.

Act 810, the method detects a change in data. One or more serves can detect a change in one of the entity, the attribute or the value, responsive to monitoring the network environment. Data change detector can monitor the network traffic and identify changes in the data. The changes in the data can correspond, relate to or involve any one or more of an entity, attribute or value of a rule, such as a rule established in act 805. The one or more servers can detect the change in one of the entity, the attribute or the value based on a comparison of an updated state of one of the entity, the attribute or the value and a prior state of the one of the entity, the attribute or the value. For example, data change detector can identify a change in the network data by identifying a change in one of the entity, attribute or value corresponding to the rule within the data monitored. Data change detector can detect the change in the data by monitoring the entity graph (e.g., the value graph) The one or more servers can monitor a value graph corresponding to the network environment. The value graph can include a representation of the network environment using the entity, the attribute and the value. The one or more servers can detect the change in one of the entity, the attribute or the value in the value graph.

At act 815, the method generates an updated rule based on the change in data. The one more servers can generate, responsive to the detection, an updated one or more rules for security of the network environment based at least on the change. For example, the one or more servers can generate the updated one or more rules in response to detecting a change in the data, such as an entity, an attribute or a value. The updated rule can be generated by the rule updated based on the changed data (e.g., the changed entity, attribute or the value). For example, the updated rule can include any one or more of the changed entity, changed attribute or the changed value. The one or more servers can generate the updated one or more rules using at least one of the entity or the attribute of the one or more rules. The one or more servers can generate the updated one or more rules responsive to detecting that the change in one of the entity, the attribute or the value is greater than a threshold. The threshold can be a set threshold amount or a range. The threshold can be based on the trigger estimate change between the rule and the updated rule.

At act 820, the method applies updated rule to previous network traffic. The one or more servers can apply the updated one or more rules to previous network traffic to which the one or more rules were applied. The one or more servers can apply the updated one or more rules to current network traffic. The one or more servers can apply the updated one or more rules to the network traffic data stored in the database. The network traffic data can include the network data gathered over a prior time period, such as a prior week, two weeks, four weeks, a month or more than a month. The updated rule can be evaluated by the effectiveness evaluator based on the stored network traffic data, while the rule (e.g., original rule stablished at act 805) can have its effectiveness evaluated and updated based on the data in real-time.

At act 825, the method determines effectiveness of the updated rule. The one or more servers can determine that an effectiveness of the updated one or more rules is greater than effectiveness of the one or more rules. The one or more servers can determine that a difference between the effectiveness of the updated one or more rules and the effectiveness of the one or more rules is greater than a threshold. Effectiveness evaluator can determine the effectiveness of the updated rule and/or the original rule (e.g., from act 805) based on the trigger percentages or trigger estimates. The effectiveness of the updated rule and/or the original rule can be determined based on the rule trigger percentages established while applying the rule to the network traffic at step 805. The effectiveness of the original rule can be determined based on the real-time performance on the real-time network data over the prior time period that corresponds to the stored network traffic that is applied to the updated rule. Effectiveness evaluator can compare the effectiveness, efficiency or performance of the updated rule against the effectiveness, efficiency or performance of the original rule (e.g., established at act 805). Effectiveness evaluator can determine that the effectiveness, efficiency or performance of the updated rule is greater than that of the original rule. Effectiveness evaluator can determine that the effectiveness, efficiency or performance of the updated rule exceeds that of the original rule by a set threshold amount, such as a set threshold of trigger percentages over the trigger percentages of the original rule.

At act 830, the method provides a recommendation. The one or more servers can provide a recommendation to use the updated one or more rules. The recommendation can be provided responsive to the determination at step 825. The one or more servers can provide for display a comparison of the effectiveness of the updated one or more rules and the effectiveness of the one or more rules. The recommendation can be provided to a system administrator. The recommendation can include a command to an application for providing and applying rules on the network (e.g., monitoring agent) to deploy, activate or apply the updated rule. The application for applying the rules on the network can then replace the original rule with the updated rule and persist or apply the updated rule going forward.

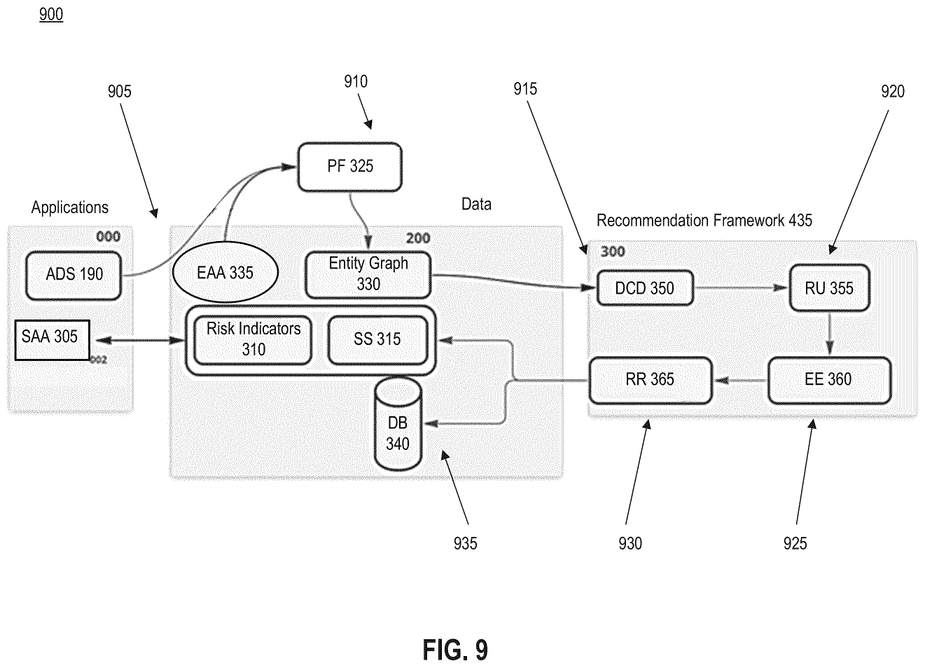

FIG. 9 illustrates a flow diagram of an example process 900 implemented by the system for generating and recommending updated rules based on changes in the network data. The process 900 can include steps 905-935, indicating the example process performed in accordance with an embodiment of the present solution.

Process 900 can begin at step 905, in which profiling framework (PF) 325 receives network data from one or more sources. PF 325 can receive data from application delivery system (ADS) 190, a security analytics application (SAA) 305 of the monitoring agent 197 and from external analytics application (EAA) 325. Data generated by ADS 190, SAA 305 or EAA 335 can include network traffic data corresponding to network traffic security analyses and can include or relate to various entities 370, attributes 375 corresponding to the entities 370 and values 380 for defining the attributes 375. Data received by the PF 325 can include or correspond to various instances of network traffic in which changes to the entities 370, attributes 375 and values 380. Data from SAA 305 can include risk indicators (RI) 310 and saved searches (SS) 315, which can correspond to the entities 370, attributes 375 and values 380 used in prior established rules 385. When a rule is created, such as by administrators at SAA 305, rule definitions can be implemented using entites 370, attributes 375 and values 380. While defining rules 385, administrators can also configure other features (e.g., attributes 375), such as severity (e.g., high, medium, low), category (e.g., compromised endpoint, compromised user etc.).

At step 910, profiling framework 325 parses and processes the data received at step 905. PF 325 can identify, parse and process data with respect to all entities 370, attributes 375 and values 380 used in all rules 385 used or deployed on the system 300 or the network 104. PF 325 can label the attributes 375 and entities 370 in use in the rules 385. PF 325 can use the data to generate an entity graph 330 (e.g., value graph). The entity graph 330 can represent the current state of network traffic, including all of the nodes of the network traffic and their most recent changes.

At step 915, data change detector (DCD) 350 can receive the entity graph 330. DCD 350 can analyze the information in the entity graph 330 an identify changes in the data corresponding to any entities 370, attributes 375 and values 380 for any of the rules 385. For example, DCD 350 can identify change in the data, based on the entity graph 330, and identify whether the changes pertain to any entities 370, attributes 375 or values 380 of a rule 385. DCD 350 can identify the rule 385 to which the change in the data corresponds.

At step 920, the process can move onto a rule updated (RU) 355 to create an updated rule 390 based on the identified rule 385 to which the data change corresponds. RU 355 can generate an updated rule 390 based on the original rule 385. RU 355 can update the change in the rule 385. For example, RU 355 can modify the entity 370, attribute 375 or value 380 to generate the updated rule 390.

At step 925, effectiveness evaluator (EE) 360 can evaluate whether the updated rule 390 is more effective than the original rule 385. EE 360 can evaluate the effectiveness of the rule 390 by applying historical network data stored in database 340 to the updated rule 390. The historical network data can correspond to the data that the original (and still enforced rule) sees on the network 104.

At step 930, when EE 360 determines that the updated rule 390 has effectiveness that exceeds that of the original rule 385, rule recommender 365 can issue and send a recommendation to use the updated rule 390 instead of the rule 385. The recommendation can include effectiveness, efficiency or performance of the updated rule 390 in comparison with that of the original rule 385.

At step 935, once accepted by the administrator, the updated rule 390 is persisted and used by the system (e.g., Citrix Analytics for Security) and used with along with the relevant risk indicator 310, saved search 315 for carrying out administrator's objectives.

Various elements, which are described herein in the context of one or more embodiments, may be provided separately or in any suitable sub-combination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
establishing, by one or more servers, one or more rules for security of a network environment, each of the one or more rules identifying an entity, an attribute of the entity and a value of the attribute;
detecting, by the one or more servers responsive to monitoring the network environment, a change in one of the entity, the attribute or the value;
generating, by the one or more servers responsive to the detection, an updated one or more rules for security of the network environment based at least on the change;
applying, by the one or more servers, the updated one or more rules to previous network traffic to which the one or more rules were applied;
determining, by the one or more servers, that an effectiveness of the updated one or more rules is greater than effectiveness of the one or more rules;
providing, by the one or more servers responsive to the determination, a recommendation to use the updated one or more rules.

2. The method of claim 1, further comprising detecting, by the one or more servers, the change in one of the entity, the attribute or the value based on a comparison of an updated state of one of the entity, the attribute or the value and a prior state of the one of the entity, the attribute or the value.

3. The method of claim 1, further comprising:
monitoring, by one or more servers, a value graph corresponding to the network environment, the value graph comprising a representation of the network environment using the entity, the attribute and the value; and
detecting the change in one of the entity, the attribute or the value in the value graph.

4. The method of claim 1, further comprising generating, by the one or more servers, the updated one or more rules using at least one of the entity or the attribute of the one or more rules.

5. The method of claim 1, further comprising generating, by the one or more servers, the updated one or more rules responsive to detecting that the change in one of the entity, the attribute or the value is greater than a threshold.

6. The method of claim 1, further comprising applying, by the one or more servers, the updated one or more rules to current network traffic.

7. The method of claim 1, further comprising determining, by the one or more servers, that a difference between the effectiveness of the updated one or more rules and the effectiveness of the one or more rules is greater than a threshold.

8. The method of claim 1, further comprising providing, by the one or more servers, for display a comparison of the effectiveness of the updated one or more rules and the effectiveness of the one or more rules.

9. A system comprising:
one or more processors coupled to memory and configured to:
establish one or more rules for security of a network environment, each of the one or more rules identifying an entity, an attribute of the entity and a value of the attribute;
detect, responsive to monitoring the network environment, a change in one of the entity, the attribute or the value;
generate, responsive to the detection, an updated one or more rules for security of the network environment based at least on the change;
apply the updated one or more rules to previous network traffic to which the one or more rules were applied;
determine that an effectiveness of the updated one or more rules is greater than effectiveness of the one or more rules;
provide, responsive to the determination, a recommendation to use the updated one or more rules.

10. The system of claim 9, wherein the one or more processors detect the change in one of the entity, the attribute or the value based on a comparison of an updated state of one of the entity, the attribute or the value and a prior state of the one of the entity, the attribute or the value.

11. The system of claim 9, wherein the one or more processors:
monitor a value graph corresponding to the network environment, the value graph comprising a representation of the network environment using the entity, the attribute and the value; and
detect the change in one of the entity, the attribute or the value in the value graph.

12. The system of claim 9, wherein the one or more processors generate the updated one or more rules using at least one of the entity or the attribute of the one or more rules.

13. The system of claim 9, wherein the one or more processors generate the updated one or more rules responsive to detecting that the change in one of the entity, the attribute or the value is greater than a threshold.

14. The system of claim 9, wherein the one or more processors apply the updated one or more rules to current network traffic.

15. The system of claim 9, wherein the one or more processors determine that a difference between the effectiveness of the updated one or more rules and the effectiveness of the one or more rules is greater than a threshold.

16. The system of claim 9, wherein the one or more processors provide for display a comparison of the effectiveness of the updated one or more rules and the effectiveness of the one or more rules.

17. A non-transitory computer readable medium storing program instructions for causing at least one processor of one or more servers to:
establish one or more rules for security of a network environment, each of the one or more rules identifying an entity, an attribute of the entity and a value of the attribute;
detect, responsive to monitoring the network environment, a change in one of the entity, the attribute or the value;
generate, responsive to the detection, an updated one or more rules for security of the network environment based at least on the change;
apply the updated one or more rules to previous network traffic to which the one or more rules were applied;
determine that an effectiveness of the updated one or more rules is greater than effectiveness of the one or more rules;
provide, responsive to the determination, a recommendation to use the updated one or more rules.

18. The non-transitory computer readable medium of claim 17, wherein the program instructions cause the at least one processor to detect the change in one of the entity, the attribute or the value based on a comparison of an updated state of one of the entity, the attribute or the value and a prior state of the one of the entity, the attribute or the value.

19. The non-transitory computer readable medium of claim 17, wherein the program instructions cause the at least one processor to generate the updated one or more rules using at least one of the entity or the attribute of the one or more rules.

20. The non-transitory computer readable medium of claim 17, wherein the program instructions cause the at least one processor to provide for display a comparison of the effectiveness of the updated one or more rules and the effectiveness of the one or more rules.
